(19) United States
(12) Patent Application Publication
(10) Pub. No.: US 2024/0204865 A1
(43) Pub. Date: Jun. 20, 2024

(54) INTEGRATED PLATFORM FOR NANOSATELLITE SYSTEM DATA PROCESSING

(71) Applicants: Raycho Raichev, Sofia (BG); Lyubomir Toshev, Sofia (BG)

(72) Inventors: Raycho Raichev, Sofia (BG); Lyubomir Toshev, Sofia (BG)

(73) Assignee: "ENDUROSAT" EAD, Sofia (BG)

(21) Appl. No.: 18/419,504

(22) Filed: Jan. 22, 2024

(30) Foreign Application Priority Data
Jul. 22, 2021 (BG) BG11340221A

(51) Int. Cl. H04B 7/185; G06Q 30/0201

(52) U.S. Cl. CPC H04B 7/18528; G06Q 30/0201; H04B 7/18515

(57) ABSTRACT

The integrated platform formed comprises one or more nanosatellites (1), each of which includes at least one sensor module (1.1) bidirectionally coupled to an on-board computer (1.2), which in turn is bidirectionally coupled to at least one communication module (1.3) bidirectionally coupled to at least one communication antenna (1.4). Each communication antenna (1.4) is coupled to at least one ground antenna (2.1) bidirectionally coupled to at least one telecommunication equipment unit (2.2) of one or more ground stations (2). Each of the ground stations (2) is bidirectionally connected to a control server (3) bidirectionally connected to a database (4), which in turn is bidirectionally connected to a market portal server (5), a developer portal server (6) and an application server (7). The control server (3), the market portal server (5), the developer portal server (6) and the application server (7) are bidirectionally connected to client stations (8.1, 8.2, 8.3 and 8.4).

### FIELD OF THE INVENTION

This invention relates to an integrated platform for processing data from nanosatellite systems that will find application in the aerospace and satellite industry, and more particularly for enabling third parties to develop, purchase and sell applications consuming useful data from space systems.

### BACKGROUND OF THE INVENTION

Space exploration and related infrastructure are becoming increasingly important to the modern world. The space sector is evolving at an extraordinary speed and this will lead to major changes in many industries in the coming years. Globally, more than 7 000 new nanosatellites are expected to be launched in the next ten years. Nanosatellites are increasingly being used for Earth observation, communications, information transfer, research and education. According to experts, nanosatellites are better suited and more effective for enabling an IoT (Internet of Things) network than larger satellites with outdated systems that cannot actually be updated. IoT is a network of all kinds of devices—from household machines to computers and even objects—with as yet untapped digital potential. With network connectivity, they exchange information with each other without the need for human interaction. This requires the presence of a mobile network almost everywhere—a service that can best be provided by satellites and satellite platforms.

The payload data generated by satellites brings added value directly to the satellite operator or to the satellite payload operator, either by using it directly or by commercializing it. Platforms exist where satellite-generated data are offered by satellite operators or payload operators for purchase by third parties. Using the purchased data, stakeholders develop algorithms and applications that consume this data. Example areas where algorithms and applications are developed are meteorology, early fire detection, agro-culture, etc. These algorithms and applications are deployed on the infrastructure of their developers and in turn are also often commercialized.

There is no known integrated platform that brings together the generation of data, the ability to commercialize it and the development of applications using that data.

### SUMMARY OF THE INVENTION

It is an object of the invention to create an integrated platform for processing data from nanosatellite systems that provides the ability to generate useful data from space, transmit and store it on Earth, and the ability to develop and deploy applications on the platform and/or on various nanosatellites.

The problem is solved by creating an integrated platform for processing data from nanosatellite systems that is composed of one or more nanosatellites, each of which includes at least one sensor module bidirectionally coupled to an on-board computer, which in turn is bidirectionally coupled to at least one communication module bidirectionally coupled to at least one communication antenna.

Each communication antenna is coupled to at least one ground antenna bidirectionally coupled to at least one telecommunications equipment unit of one or more ground stations. Each of the ground stations is bidirectionally coupled to a control server bidirectionally coupled to a database, which in turn is bidirectionally coupled to a market portal server, a developer portal server, and an application server. The control server, the market portal server, the developer portal server and the application server are bidirectionally connected to client stations of payload operators, to client stations of market portal users, to client stations of application developers and to client stations of ground application users.

The advantage of an integrated platform for processing data from nanosatellite systems is that it ensures the generation of payload data from space, its transmission and storage on Earth for use of both nanosatellite payload operators and third parties. The platform also has the advantage of providing the ability to build algorithms and applications using the data, and the applications can be deployed on both the platform and the nanosatellites.

### BRIEF DESCRIPTION OF THE DRAWINGS

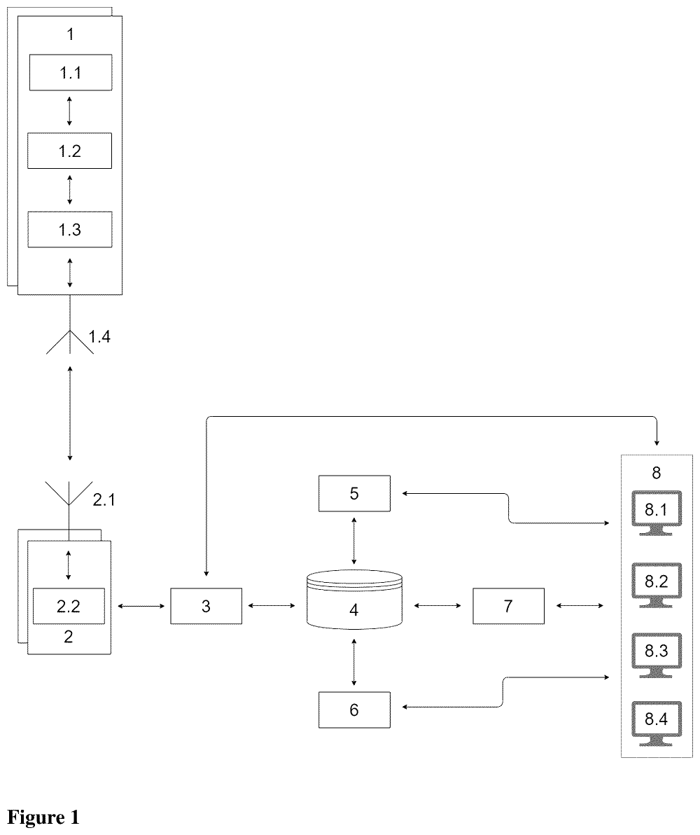

The present invention is illustrated in the attached FIG. 1, which is a schematic in principle of an integrated platform for processing data from nanosatellite systems according to the invention.

### DETAILED DESCRIPTION OF THE INVENTION

The embodiment of an integrated platform for processing data from nanosatellite systems shown in FIG. 1 comprises one or more nanosatellites 1, each of which comprises at least one sensor module 1.1 bidirectionally coupled to an on-board computer 1.2, which in turn is bidirectionally coupled to at least one communication module 1.3 bidirectionally coupled to at least one communication antenna 1.4. The platform further comprises one or more ground stations 2, each comprising at least one ground antenna 2.1 and a telecommunications equipment unit 2.2.

Each communication antenna 1.4 is coupled to at least one of the ground antennas 2.1. Each of the ground stations 2 is bidirectionally connected to a control server 3, which takes care of their control, command transmission and satellite data reception. The control server 3 is bidirectionally connected to a database 4, which in turn is bidirectionally connected to a market portal server 5, a developer portal server 6 and an application server 7. The control server 3, the market portal server 5, the developer portal server 6, and the application server 7 are bidirectionally connected to client stations of payload operators 8.1, to client stations of market portal users 8.2, to client stations of application developers 8.3, and to client stations of ground application users 8.4.

The components of the established integrated platform for nanosatellite data processing have the following characteristics: The sensor module 1.1, on each nanosatellite 1, represents the so-called payload and contains various sensor devices such as camera, magnetometer, etc. to collect information from space. Through its bidirectional connection to the on-board computer 1.2, the sensor module 1.1 can record the data collected on it or receive control commands.

The on-board computer 1.2 is the module on which the main part of the nanosatellite 1 software is executed. It consists of microcontrollers, connectors, external memory card slots and other necessary components. Through the telecommunications module 1.3, the on-board computer 1.2 transmits data from the sensor module 1.1 for download to Earth or receives commands from Earth for transmission to the sensor module 1.1.

The communication module 1.3 is used to transfer data between the Earth and the nanosatellite 1. It may include a UHF transceiver supporting a low rate of 20 Kbits/sec, which does not require pointing to Earth. It may also include an S-band transmitter that supports a higher rate of 5 Mbits/sec and is used to transmit larger data and telemetry from the satellite to Earth. The 1.3 communication module is also capable of incorporating additional fast RF communication devices such as an X-band transmitter, Ka-band transmitter, W/V band transmitter, etc. They support high data rates from the satellite to the Earth from 150 Mbits/s to several Gbits/s, in different bands of the radio spectrum. They are used for fast transmission of large amounts of information from the satellite to the Earth, such as pictures and/or video.

The communication antenna 1.4 can be a UHF antenna that consists of a mechanical frame, a microcontroller control board and connectors, and metal antennas with a mechanism to unfold them. The communication antenna 1.4 may also be an S-band antenna, an X-band antenna and/or an antenna for other frequencies, which comprise a circuit board with separate metal patches and a connector. The communications antenna 1.4 receives the data collected for downlink to Earth by the telecommunications module 1.3, or transmits the received control commands to the nanosatellite 1.

On the other hand, the ground antenna 2.1 is a mechanical radio antenna for receiving and transmitting radio signals. It consists of an antenna and a pointing mechanism, which are adjusted and controlled by the respective ground station 2 to establish radio communication with the nanosatellite 1. The ground antenna 2.1 receives the data from the nanosatellite 1 and transmits commands for its control via the telecommunications equipment unit 2.2.

The control server 3 is a computer server or cluster of servers that can receive commands from mission operators for transmission to the ground stations 2 and display satellite information to them from the database 4 via the personal client stations of payload operators 8.1. The control server 3 records the received satellite data and the received commands in the database 4. The mission or payload operators may also allow the data from their sensor modules 1.1 (payloads) to be commercially available on the market portal server 5 for a fee. From the client stations of payload operators 8.1 it is also possible to control purchased applications for deployment on satellite.

The database 4 is a computer server or cluster of servers for storing satellite data, satellite commands, applications and meta information. The meta information is data describing the nanosatellite 1 itself, information about its behaviour over time, location, etc. The database 4 receives satellite data and transmits commands to the control server 3; receives applications and transmits satellite data to the market portal server 5; receives applications and transmits meta information to the developer portal server 6; and transmits satellite data and meta information and receives new meta information from the application server 7.

The market portal server 5 is a computer server or cluster of servers that provides its users with the ability to search, find and purchase applications and/or satellite data. Market portal users connect to the market portal server 5 over a bidirectional connection through the client stations of market portal users 8.2. If users are payload operators, they may purchase applications for deployment on nanosatellites 1. If they are ground application users, they can purchase the relevant ground application and gain subsequent access to them via the application servers 7.

The developer portal server 6 is a computer server or cluster of servers that provides its application developer users with access to application development tools and to publish new applications. The developer portal server 6 is accessed through the client stations of application developers 8.3.

The application deployment server 7 is a computer server or cluster of servers. It provides the infrastructure for deploying the applications created. From it, users can access or retrieve the deployed applications from the database 4 via the client stations of the ground application users 8.4.

What is claimed is:

1. An integrated nanosatellite data processing platform, characterized in that it is composed of one or more nanosatellites (1), each including at least one sensor module (1.1) bidirectionally coupled to an on-board computer (1.2), which in turn is bidirectionally coupled to at least one communications module (1.3) bidirectionally coupled to at least one communications antenna (1.4), each communications antenna (1.4) coupled to at least one ground antenna (2.1) bidirectionally coupled to at least one telecommunications equipment unit (2.2) of one or more ground stations (2), wherein each of the ground stations (2) is bidirectionally coupled to a control server (3) bidirectionally coupled to a database (4), which in turn is bidirectionally coupled to a market portal server (5), to a developer portal server (6) and to an application server (7), the control server (3), the market portal server (5), the developer portal server (6) and the application server (7) being bidirectionally connected to client stations of payload operators (8.1), to client stations of market portal users (8.2), to client stations of application developers (8.3) and to client stations of ground application users (8.4).
